(19) United States
(12) Patent Application Publication
(10) Pub. No.: US 2018/0191482 A1
(43) Pub. Date: Jul. 5, 2018

(54) ADJACENT FREQUENCY BANDS

(71) Applicant: NOKIA SOLUTIONS AND NETWORKS OY, Espoo (FI)

(72) Inventor: Wolfgang ZIRWAS, Munich (DE)

(21) Appl. No.: 15/737,741

(22) PCT Filed: Jun. 17, 2015
(86) PCT No.: PCT/EP2015/063514

§ 371 Date: Dec. 18, 2017

(51) Int. Cl. H04L 5/14; H04W 72/04; H04L 5/00

(52) U.S. Cl. CPC H04L 5/14; H04L 5/0073; H04W 72/044

(57) ABSTRACT

To take into account a possible interference between adjacent frequencies and yet minimizing overhead, a first transmission mode used in a first frequency band and a second transmission mode used in a second frequency band that is adjacent to the first frequency band are determined, the transmission modes are compared, and based on an outcome of the comparing a size of a guard band to be used between the first frequency band and the second frequency band is determined.

### TECHNICAL FIELD

The invention relates to wireless communications.

### BACKGROUND

The following description of background art may include insights, discoveries, understandings or disclosures, or associations together with dis-closures not known to the relevant art prior to the present invention but provided by the invention. Some such contributions of the invention may be specifically pointed out below, whereas other such contributions of the invention will be apparent from their context.

In recent years, the phenomenal growth of mobile Internet services and proliferation of smart phones and tablets has increased use of mobile broadband services, and hence use of available spectrum. One way to increase the air interface capacity is to allow different network operators to use adjacent frequency bands in the same geographical area. However, when adjacent frequency bands are used in the same geographical area, adjacent channel interference should be taken into account.

### BRIEF DESCRIPTION

According to an aspect, there is provided the subject matter of the independent claims. Embodiments are defined in the dependent claims.

### BRIEF DESCRIPTION OF DRAWINGS

In the following, the invention will be described in greater detail by means of preferred embodiments with reference to the attached drawings, in which

FIG. 1 shows simplified architecture of a system and block diagrams of some exemplary apparatuses;

FIGS. 2, 3 and 4 are flow charts illustrating exemplary functionalities;

FIGS. 5 and 6 is an exemplary signaling chart; and

FIG. 7 is a schematic block diagram of an exemplary apparatus.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any network/system configured to use guard bands, also called guard intervals, a guard band being an allocation of spectrum that is intended to be unused, or used with restricted access only, to prevent interference, between adjacent frequency bands to overcome adjacent channel interference, and entities/nodes/apparatuses in such a network/system. Examples of such networks/systems include Long Term Evolution Advanced (LTE-A) access system, Worldwide Interoperability for Microwave Access (WiMAX), LTE Advanced, 4G (fourth generation) and beyond, such as and 5G (fifth generation), cloud networks using Internet Protocol, mesh networks, and ad-hoc networks, such as LTE direct and mobile ad-hoc network (MANET), ultra dense networks, device-to-device networking systems, relaying networks, peer-to-peer networking systems, like Internet of Things systems, wireless sensor network systems, or any combination thereof. The specifications of different systems and networks, especially in wireless communication, develop rapidly. Such development may require extra changes to an embodiment. Therefore, all words and expressions should be interpreted broadly and they are intended to illustrate, not to restrict, the embodiment. For example, future networks will most probably utilize network functions virtualization (NFV) which is a network architecture concept that proposes virtualizing network node functions into “building blocks” or entities that may be operationally dynamically instantiated, connected or linked together to provide network services. A virtualized network function (VNF) may comprise one or more virtual machines that run computer program codes using standard or general type servers instead of customized hardware. In other words, the concept proposes to consolidate many network equipment (apparatus, node) types onto standard servers whose hardware can run computer program codes implementing network functions, without a need for installation of new equipment. Cloud computing and/or data storage may also be utilized. In radio communications this may mean node operations to be carried out, at least partly, in a server, host or node operationally coupled to a remote radio head. It is also possible that node operations will be distributed amongst a plurality of servers, nodes or hosts. Another networking paradigm is software-defined networking (SDN) in which lower-level functionality is abstracted by decoupling data forwarding (data plane) from overlying control decisions, such as routing and resource allocations. This is achieved by means of one or more software-based SDN controllers that allow the underlying network to be programmable via the SDN controllers independent of underlying network hardware. Hence, it should be understood that the distribution of labor between core network operations and access network operations, such as base station operations, may differ from that of the one described here, or even be non-existent, and the below described base station functionality may be migrated to any corresponding abstraction or apparatus.

In the following, embodiments for adjusting the guard band are discussed in further detail using a base station as an example of the adjusting apparatus, without restricting the examples to such a solution. In other words, in the below examples interference between two base stations is used as an example, without limiting the solution to such an example. Interference between two user devices and interference between a user device and a base station have the same nature, although their impact may be smaller to an entire cell or sector than what the interference between two base stations may have. Therefore a similar approach is a straightforward implementation detail, and easily achievable for one skilled in the art in different interference scenarios.

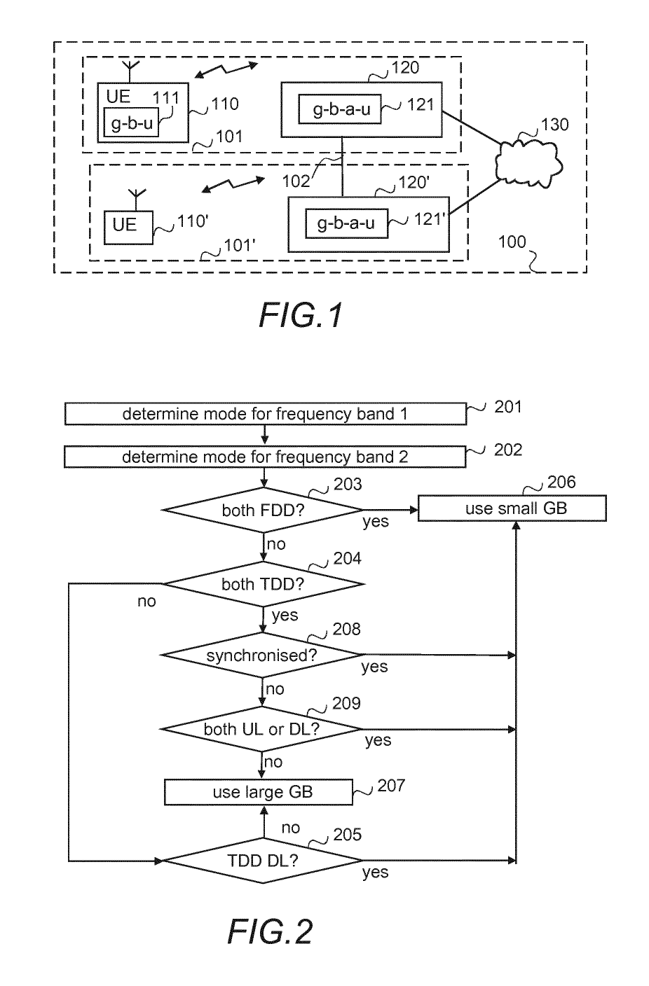

An extremely general architecture of an exemplifying system 100 is illustrated in FIG. 1. FIG. 1 is a simplified system architecture only showing some elements and functional entities, all being logical units whose implementation may differ from what is shown. It is apparent to a person skilled in the art that the system comprises other functions and structures that are not illustrated, for example connections to the core networks/systems.

In the embodiment illustrated in FIG. 1, the system 100 comprises two wireless access networks 101, 101′ both providing access to the system for user devices 110, 110′ (only one per access network is shown in FIG. 1) by means of access point nodes 120 (only one per access network is shown in FIG. 1), wherein an access point may be connected to one or more other network nodes and/or access nodes and/or to other networks 130, such as Internet, either via a core network or directly. In the illustrated example it is assumed that the access points have adjacent frequencies and the same or overlapping geographical coverage, and that they are connected over an interface 102 to each other. The interface 102 may be an X2 interface, for example.

The user device 110, 110′ refers to a portable computing device (equipment, apparatus), and it may also be referred to as a user terminal or mobile terminal or a machine-type-communication (MTC) device, also called Machine-to-Machine device and peer-to-peer device. Such computing devices (apparatuses) include wireless mobile communication devices operating with or without a subscriber identification module (SIM) in hardware or in software, including, but not limited to, the following types of devices: mobile phone, smart-phone, personal digital assistant (PDA), handset, laptop and/or touch screen computer, e-reading device, tablet, game console, notebook, multimedia device, sensor, actuator, video camera, car, refrigerator, other domestic appliances, telemetry appliances, and telemonitoring appliances. The user device does not need any modifications, but a user device, as in the illustrated example one of the user devices 110, 110′ is configured to receive information on guard bands currently in use and to use the information to determine where in a physical downlink shared channel, for example, to expect user data targeted to the user device. For that purpose the user device 110 may comprise a guard band unit (g-b-u) 111 that performs the processing and provides the necessary configuration to the user device 110.

The access point node 120, 120′ or any corresponding network entity (network apparatus, network node, network equipment) is an apparatus providing over-the-air access, including resource allocation, to a network (wireless or wired) 130 the access point is connected to, and the access point node may be configured to support one or more wireless access. Examples of such apparatuses include an evolved node B and a base station or any other access node. The access node 120, 120′ is configured to support adjustable guard band width. For that purpose the access node may comprise a guard band adjusting unit (g-b-a-u) 121, 121′. Examples of the functionality of the guard band adjusting unit will be described in more detail below. It should be appreciated that the access node may have any number of reception and/or transmission antennas (not shown in FIG. 1).

In wireless systems, such as a radio system, different channel access methods are used. Below different examples will be described using frequency division duplex (FDD) and time division duplex (TDD) as an example of wireless access methods, without restricting the examples to such a solution. Further, in another type of access methods, interference may happen between other modes than the ones used below. However, implementing the below described functionality to other similar “interference criteria” is a straightforward process to one skilled in the art.

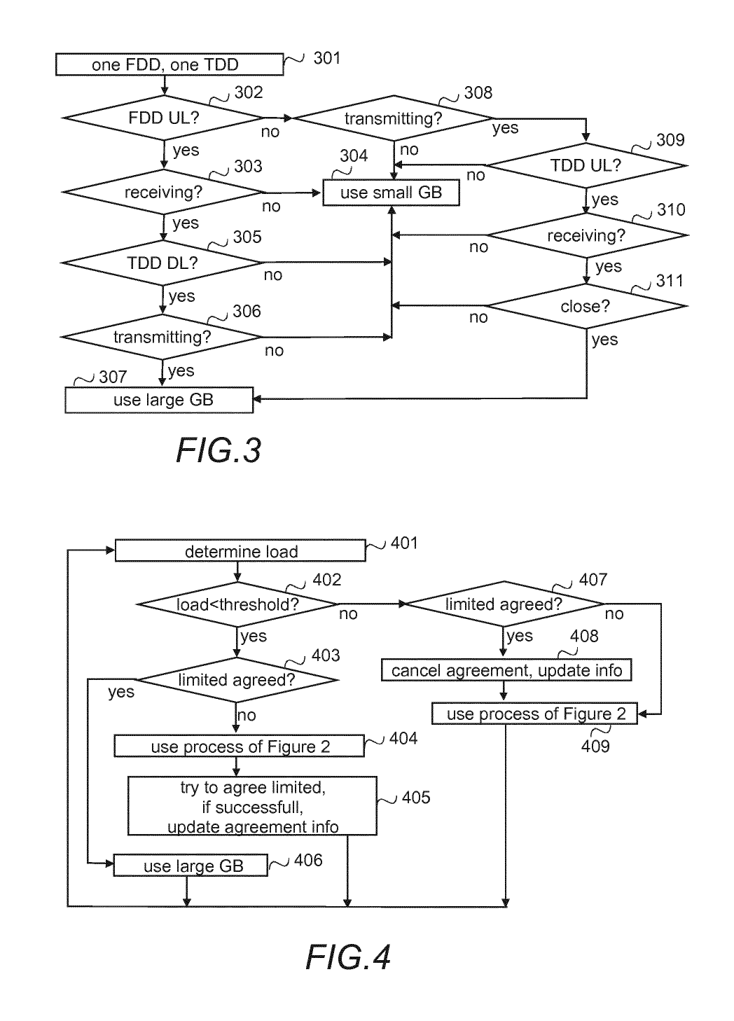

The examples illustrated in FIGS. 2 to 5 describe exemplary functionalities of a guard band adjusting unit in a base station, including functionalities the guard band adjusting unit causes other units in the base station to perform. For the sake of clarity, term base station is used in the below examples as a performer of the exemplary functionalities. In the examples it is assumed that the base station determines its own guard band, or more precisely its own portion of the guard band. Depending on agreements between the operators on adjacent frequencies, the actual guard band may be allocated evenly to both operators, i.e. half and half, or unevenly. The even allocation is a fair allocation and suitable especially when predefined or agreed guard band values are used. The uneven allocation may be a suitable allocation, if most of the time the other has a low to medium load, whereas the other one has a medium to high load, or if one of the operators has one or more legacy base stations (a legacy base station meaning a base station that is not configured to adapt the guard band.

In the example illustrated in FIG. 2, it is assumed that the base station is configured to switch between two different guard bands (i.e. two different sizes for a guard band), a large guard band and a small guard band. However, it should be appreciated that there may be more guard bands, as will be described below.

In the example it is assumed that the process is performed sub-frame—specifically. A sub-frame means herein a part of a frame, the part comprising a control portion and a traffic portion. The traffic portion is either for uplink traffic or for downlink traffic, depending on the transmission (operation) mode. For the time division duplex the sub-frame may correspond to a minimum scheduling unit in time. It should be appreciated that the adaptation process should be performed such that it follows variations of uplink and downlink sub-frames within a frame, i.e. on transmission time interval (TTI) level.

Referring to FIG. 2, the base station operates in a frequency band 1, and the adjacent frequency band is 2. The base station determines in step 201 a transmission mode of the frequency band 1 for the sub-frame. How accurately the transmission mode is determined, depends on the division duplex system used in the illustrated example. When the frequency division duplex is in use, the transmitter and the receiver operate at different sub-bands. If both base stations in adjacent frequencies are using the frequency division duplex, they do not “hear” each other and will normally not interfere with each other. Hence, it is not necessary to determine the transmission mode more accurately. However, it could be determined more accurately. When the time division duplex is in use, the situation is more complicated, and it is advisable to determine the transmission mode more accurately. Examples of the more accurate determinations are given below.

The base station further determines in step 202 a transmission mode of the frequency band 2 currently in use. There are several ways how this determination may be performed. For example, the base stations involved may exchange information on their mode in use over the interface between the base stations. Another example is that the base station listens control channels transmitted by the other base station, and deduce from the information the mode. For example, one over the air (OTA) sub-frame may be used to exchange such information, wherein the base station either listens when the other base station is transmitting, or vice versa. Naturally, for the frequency division duplex, the frequency bands have to be switched when switching from transmitting mode to listening mode. A further possibility is to receive the information indirectly, as a kind of a side product of filter adaptation for suppression of interference, or use the same information. Yet another alternative to is to use a test receiver, such as a user device module, arranged to the base station, for example; or the base station may obtain information from such a test receiver arranged to another base station in the same frequency band. Regardless of the way how the information needed for the determination is obtained, it should be appreciated that the information should be available in time, i.e. the delay in the information exchange should be short enough to allow adjustment of the guard band at a proper time. Further, it should be appreciated that although the adaptation is performed sub-frame specifically, the determination step 202 may use previous information. For example, if a frame structure is defined semi-statically based on uplink-downlink asymmetries, there is no need to perform information exchange between the base stations every time the adaptation is performed.

The base station compares the modes with each other. In other words, it is checked in step 203, whether or not both base stations are operating in a frequency division duplex (FDD) mode. If not, it is checked in step 204, whether or not both base stations are operating in a time division duplex (TDD) mode. If not, then one of the base stations is operating in a frequency division duplex mode and the other one in a time division duplex mode. In such a situation, the time division duplex mode needs to be determined in the accuracy of a link direction to determine which guard band to use. In other words, in the example illustrated in FIG. 2, it is checked in step 205, whether or not the time division duplex mode is a time division duplex (TDD) downlink (DL) mode. The checking is due to the fact that time division duplex band in the downlink mode is, such as the frequency division duplex mode, robust to the interference. However, in the uplink mode (UL) the time division duplex band have to be protected against interference, such as adjacent channel leakage ratio (ACLR).

Therefore, if one of the adjacent bands is in the frequency division duplex mode and the other one in a time division duplex downlink mode (step 205), the small guard band (GB) is sufficient and will be used (step 206). Otherwise, i.e. if one of the adjacent bands is in the frequency division duplex mode and the other one in a time division duplex uplink mode (step 205), the large guard band (GB) is needed and will be used (step 207).

If both of the adjacent bands are in the frequency division duplex mode (step 203), and hence not interfering, as explained above, the small guard band (GB) is sufficient and will be used (step 206).

If both of the adjacent bands are in the time division duplex mode (step 203), the time division duplex mode needs to be determined a little bit more accurately. If the adjacent bands are synchronised (step 208), i.e. the mode is synchronised time division duplex mode, the frequency bands are in principle aligned, and hence not interfering. Therefore the small guard band is sufficient and will be used (step 206).

However, if the adjacent bands are not synchronised (step 208), the accuracy of a link direction is needed to determine which guard band to use. If the link direction in the adjacent band is the same, they are not interfering. The situation is contrary, if one of the adjacent bands is in a time division duplex uplink mode and the other one in a time division duplex downlink mode. In other words, it is checked in step 209, whether both adjacent bands are either in the uplink mode (UL) or in the downlink mode (UL). If they are, the small guard band is sufficient and will be used (step 206). If they are not, the large guard band will be used (step 207).

In other exemplary implementations, the accuracy of the time division duplex mode is not necessary determined in so detail. For example, determination of the uplink mode and the downlink mode may be skipped, if both bands are in the time division duplex asynchronous mode, and/or one of them is in the time division duplex mode, and the large guard period will be used without further checking. In other words, step 209 and/or step 205 may be omitted and the process may proceed to step 207.

In further exemplary implementations, the downlink and uplink accuracy may be used also for the frequency division duplex, and/or the accuracy may be determined even to “transmitting or not” level, at least before deciding to use the large guard band. FIG. 3 illustrates an example of such a situation.

Referring to FIG. 3, the example starts in the situation wherein it is detected in step 301 that one of the frequency bands is in frequency division duplex mode and the other one is in the time division duplex mode. (In other words, answer to the question of step 204 in FIG. 2 is no.) Since in the illustrated example the more accurate determination is used, it is checked in step 302, whether or not the frequency division duplex mode is a frequency division duplex (FDD) uplink (UL) mode. The checking is due to the fact that frequency division duplex band in the uplink mode may cause interference and/or suffer from interference but in the downlink mode it does not cause interference or suffer from interference.

If the mode is the frequency division duplex uplink mode (step 302), it is checked in step 303, whether the frequency division duplex uplink is receiving or inactive. The reason is that interference is caused and will effect only if something is transmitted over the air interface. So if the frequency division duplex uplink is inactive, the zero or small guard band is used (step 304).

If the frequency division duplex uplink is receiving (step 303), there is a possibility for interference with the time division duplex band if the transmission mode is time division duplex downlink. Therefore it is checked, in step 305, whether or not the other transmission mode is the time division duplex downlink mode. If not, the zero or small guard band is used (step 304).

If the mode is the time division duplex downlink mode (step 305), it is checked in step 306, whether or not the time division duplex downlink is transmitting, the reason being that interference is caused and will effect only if there something is transmitted. If nothing is transmitted in the time division duplex downlink, i.e. it is inactive, the zero or small guard band is used (step 304).

However, if the time division duplex downlink is transmitting (step 306), and the frequency division duplex uplink is receiving, the interference most probably will occur, and the large guard band is used in step 307.

If the transmission mode is frequency division duplex downlink (answer no in step 302), it is checked in step 308, whether the frequency division duplex uplink is transmitting or inactive. The reason is that interference is caused and will effect only if something is transmitted over the air interface. So if the frequency division duplex uplink is inactive, the zero or small guard band is used (step 304).

If the frequency division duplex uplink is transmitting (step 308), there is a possibility for interference with the time division duplex band if the transmission mode is time division duplex uplink. Therefore it is checked, in step 309, whether or not the other transmission mode is the time division duplex uplink mode. If not, the zero or small guard band is used (step 304).

If the mode is the time division duplex uplink mode (step 309), it is checked in step 310, whether or not the time division duplex uplink is receiving, the reason being that interference is caused and will effect only if there something is transmitted. If nothing is received in the time division duplex uplink, i.e. it is inactive, the zero or small guard band is used (step 304).

However, if the time division duplex uplink is receiving (step 310), and the frequency division duplex uplink is transmitting, the interference may occur if the frequency bands allocated for the traffic are close to each other (step 311). If, the frequency bands allocated for the traffic are close to each other the large guard band is used in step 307. If they are not close to each other (step 311), the zero or small guard band is used (step 304). The frequency bands allocated for the traffic may be deemed to be close to each other if the difference is less than the size of the large guard band, for example. It should be appreciated that other limits may be used as well.

In the above examples the dynamic adjusting of guard band size is performed regardless of the transmission mode of the base station. However, the dynamic adjusting of the guard band size in a base station may be triggered in response to the base station starting to use the time division duplex mode on the frequency band, and the dynamic adjustment is performed as long as the time division duplex mode is in use. In that situation the determining of the transmission mode described above with step 201 is inherently performed when the decision to take the time division duplex mode is made, and there is no need to perform the checking described above with step 203, and if performed, the answer will be always “no”. Further, in an implementation a base station in a frequency division duplex mode may be configured to trigger the dynamic adjusting in response to detecting that the other base station starts/has started/will start to use the time division duplex mode, and to perform it as long as the other one is using the time division duplex mode. For the latter implementation, the base stations may be configured to inform the base station on the adjacent frequency band when they start to use the time division duplex mode and when they end to use it. Naturally the information is obtainable also in the ways described above with step 202.

Although in the above examples two sizes for a guard band are used, one should appreciate that there may be several sizes for a guard band. For example, in the situation in which both are in the frequency division duplex mode, the size of the small guard band may be zero, and in the other situations the size of the small guard band may be more than zero, for example 0.5 or 1 MHz, or 10% of the frequency band, or 7.5% of the frequency band, or for each situation own small guard band size may be defined. Correspondingly, the size of the large guard band may be different for different situations. For example, the large guard band could be 10 MHz if both adjacent frequency bands are in the time division duplex mode and 5 MHz in the other situations. To summon up, in the illustrated examples, there may be two, three, four, five or six different guard band sizes, amongst which the base station determines (selects) which to use. Further, one or more or all of the sizes for a guard band to be used may be predetermined, and/or one or more or all of the sizes for the guard band to be used may be determined/adjusted as a background process. The background process may be continuous, or repeated at certain intervals, or repeated randomly. In situations in which certain synchronization accuracy is reliable enough, there may be only one adjustment process, or the information on the synchronization accuracy may be used as such to determine the size of the guard band. The used waveform may be taken into account when determining the size of the guard band. Currently the size of a guard band required to overcome the interference, i.e. a guard band corresponding the large guard band herein, is 25% of the frequency band. However, new waveforms tackling the interference are under development and if they are taken into use, at least the size of the large guard band, possibly also the size of the small guard band may be reduced.

To summon up the procedure, one determines the modes in which inter-band interference, or strong inter-band interference, happens, and uses a large guard band in those modes, otherwise a zero or a small guard band can be used.

As is evident from the above, the large guard band is used only in certain specific situations in which it is actually needed. Hence the overall extra overhead caused by the guard band will decrease, and the available band for user traffic will increase. That applies even if the size of the large guard band is 25% of the frequency bandwidth, the size of the small guard band is 10% of the frequency bandwidth, and zero size guard band is used only when orthogonal frequency division multiplexing is used and completely synchronized. This dynamic adaptation of guard band size will be especially useful if frequencies below 6 GHz will be taken into use so that large chunks of frequency bands are not available.

FIG. 4 illustrates an exemplary implementation in which the base station, for example the guard band adaptation unit, or a scheduling unit, or the units together, are configured to use a kind of two phase adaptation of the size of the guard band. This provides a kind of semi-static (semi-permanent) guard band. The phases are called herein a limited load phase and loaded phase. Other names may be used as well. For example, they may be called “no adjustment” phase and “fast adjustment” phase. The limited load phase is a more simple mode in which the amount of control information to be transmitted between the base station may be minimized, thereby minimizing the amount of control overhead. Further, in the illustrated example it is assumed that the base stations operating in the adjacent frequencies are configured to use the limited load phase only if agreed by both base stations. If not agreed, it may be that the base station in the loaded phase will not receive control information needed for adjustments from the other base station that is in the limited load phase. Referring to FIG. 4, the base station determines in step 401 a traffic load in its frequency band 1, and compares in step 402 the load to a preset threshold for the load. It should be appreciated that the preset threshold for the load may be freely set but it should be a value that provides a certain quality of experience to users in the limited load phase.

If the load does not exceed the preset threshold for the load (step 402), it is checked in step 403, whether or not there is an agreement to use a limited load phase. If there is not such an agreement, the adaptation process described above with FIG. 2 is used in step 404. Naturally, the accuracy of the adaptation process may be different from the one disclosed in FIG. 2. For example, the accuracy described with FIG. 3 may be used. Then the base stations tries in step 405 to agree with the other base station on the use of the limited load phase. The signalling used herein may be reuse some existing signalling, like Inter-Cell Interference Coordination (ICIC) messages, for example, over the interface between the base stations, or dedicated messages, such as messages tailored to this agreement process. If the other base station agrees, the agreement information is updated correspondingly in step 05. Then the process proceeds back to step 401 to determine the load.

If there is an agreement (step 403), the large guard band is used in step 306, and the process proceeds back to step 401 to determine the load. Hence no user data traffic will be allocated, not even in a time division duplex uplink mode, to resource blocks that may suffer from interference.

The use of the semi-static guard band saves base station resources since the mode determinations and guard band adaptations are performed only when the air band capacity is needed.

If the load exceeds the preset threshold for the load (step 402), it is checked in step 407, whether or not there is an agreement to use a limited load phase. If there is, the base station cancels in step 408 the agreement by sending corresponding information to the other base station and by updating its own agreement information correspondingly, and then the process described above with FIG. 2 is performed in step 409. After that the process proceeds to step 401 to determine the load.

If the load exceeds the preset threshold for the load and if there is no agreement (step 407), the process proceeds directly to step 409 to perform the adaptation process described above with FIG. 2. Naturally, the accuracy of the adaptation process may be different from the one disclosed in FIG. 2. For example, the accuracy described with FIG. 3 may be used.

Although not illustrated in FIG. 4, if the base station receives a cancellation of the agreement from the other base station, it will update its agreement information correspondingly. Further, if the base station receives a request for the agreement, the base station uses the load situation to determine whether to accept (load does not exceed the threshold) or to reject (load exceeds the threshold) the request, sends corresponding information, and updates agreement status correspondingly.

The limited load phase may also be used without any agreement. In such an implementation, if the load remains under the threshold, the large guard band is used and if the load exceeds the threshold, the guard band adaptation process will be used. Referring to FIG. 4, it means that steps 403, 404, 405, 407 and 408 are skipped over.

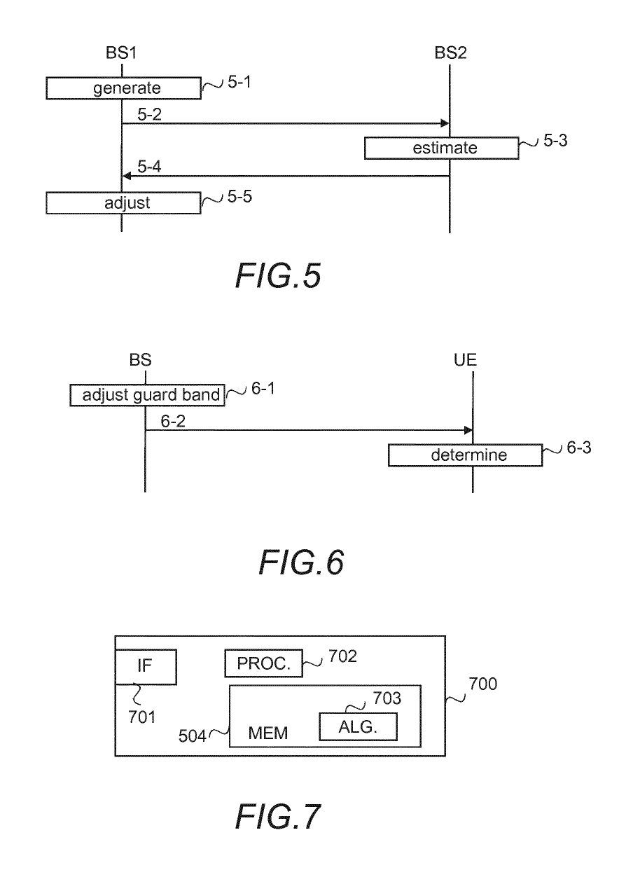

FIG. 5 illustrates information exchange between the two base stations having adjacent bands, the information being exchanged in order the two base stations to synchronize in frequency themselves so that the guard bands may be reduced and overhead caused by the guard bands minimized. The process may be triggered in response to taking time division duplex into use. However, it should be appreciated that the synchronization of the uplink and downlink phases for time division duplex frames is different from the described process.

Once the process is triggered, the base station BS1 generates in point 5-1 one or more measurement signals 5-2. For example, SI functions, defined as SI(x)=sin(x)/x and relating to orthogonal frequency-division multiplexing (OFDM) waveforms as defined for LTE may be used. An advantage provided by the SI functions is that they have periodic zeros and if two base stations are properly synchronized their mutual interference will be zero as well.

When the base station BS2 receives the one or more measurement signals 5-2, it estimates in point 5-3, using the detected interference of the one or more measurement signals, current frame start offset and the frequency offset between the transmissions on the adjacent bands. The estimated offsets are then reported back to the base station BS1 in message 5-4. The base station BS1 uses the received information to adjust in point 5-5 its frame start and frequency so that the difference between the adjacent bands is minimized. The above procedure may be repeated until the base station BS1 detects that the adjacent bands are synchronised, i.e. aligned in time and frequency, or at least almost aligned. It should be appreciated that there may always be some residual estimation errors.

In another implementation the base station BS2 may adjust its own transmission instead of estimating. Further, the process may be performed step-by-step, i.e. repeated until the synchronisation is achieved.

The example illustrated in FIG. 6 describes exemplary functionality in an implementation in which the user device is informed on the guard band used or its adjustment. For example, the guard band adjusting unit in a base station and the guard band unit in the user device may be configured to perform the functionality described below. However, for the sake of clarity, terms base station and user device are used in the below as performers of the exemplary functionality.

Referring to FIG. 6, when the base station BS adjusts in point 6-1 its guard band, it sends message 6-2 to user devices (only one UE illustrated in FIG. 6 for the sake of clarity). The message may contain the size of the guard band after adjustment, an indication which guard band is used after the adjustment, an indication how much the previous guard band is reduced or increased, etc. In response to receiving message 6-2, the user device UE determines in point 6-3 where in a physical downlink shared channel, for example, to expect user data targeted to the user device.

Although in the above examples one guard band for a base station is described, it should be appreciated that the examples may be used also in situations in which there are multiple guard bands for the base station (or multiple guard bands for a user device).

The steps, points and messages (i.e. information exchange) and related functions described above in FIGS. 2 to 6 are in no absolute chronological order, and some of the steps/points may be performed simultaneously or in an order differing from the given one. Other functions can also be executed between the steps/points or within the steps/points, and other information may be sent. For example, a radio frequency filter may be switch off when the small or zero guard band is taken into use. Some of the steps/points or part of the steps/points can also be left out or replaced by a corresponding step/point or part of the step/point.

The techniques described herein may be implemented by various means so that an apparatus/network node/user device implementing one or more functions/operations of a corresponding apparatus/network node/user device described above with an embodiment/example, for example by means of FIGS. 2, 3, 4, 5 and/or 6, comprises not only prior art means, but also means for implementing the one or more functions/operations of a corresponding functionality described with an embodiment, for example by means of FIGS. 2, 3, 4, 5 and/or 6, and it may comprise separate means for each separate function/operation, or means may be configured to perform two or more functions/operations. For example, one or more of the means and/or the guard band adjusting unit and/or the guard band unit for one or more functions/operations described above may be software and/or software-hardware and/or hardware and/or firmware components (recorded indelibly on a medium such as read-only-memory or embodied in hard-wired computer circuitry) or combinations thereof. Software codes may be stored in any suitable, processor/computer-readable data storage medium(s) or memory unit(s) or article(s) of manufacture and executed by one or more processors/computers, hardware (one or more apparatuses), firmware (one or more apparatuses), software (one or more modules), or combinations thereof. For a firmware or software, implementation can be through modules (e.g., procedures, functions, and so on) that perform the functions described herein. More detailed description on the guard band adjusting unit is provided by means of FIG. 7. It should be appreciated that the description is applicable to the guard band unit in a user device as well, and therefore it is not repeated herein.

FIG. 7 is a simplified block diagram illustrating some units for an apparatus 700 configured to be a wireless access apparatus (access node), comprising at least the guard band adjusting unit, or configured otherwise to perform functionality described above, for example by means of FIG. 2 and/or FIG. 3 and/or FIG. 4 and/or FIG. 5 and/or FIG. 6, or some of the functionalities if functionalities are distributed in the future. In the illustrated example, the apparatus comprises an interface (IF) entity 701 for receiving and transmitting information, an entity 702 capable to perform calculations and configured to implement at least the guard band adjusting unit described herein, or at least part of functionalities/operations described above, for example by means of FIG. 2 and/or FIG. 3 and/or FIG. 4 and/or FIG. 5 and/or FIG. 6, as a corresponding unit or a sub-unit if distributed scenario is implemented, with corresponding algorithms 703, and memory 704 usable for storing a computer program code required for the guard band adjusting unit, or a corresponding unit or sub-unit, or for one or more functionalities/operations described above, for example by means of FIG. 2 and/or FIG. 3 and/or FIG. 4 and/or FIG. 5 and/or FIG. 6, i.e. the algorithms for implementing the functionality/operations described above by means of FIG. 2 and/or FIG. 3 and/or FIG. 4 and/or FIG. 5 and/or FIG. 6. The memory 704 is also usable for storing other possible information, like different sizes for a guard band, conditions when to use what guard band, etc. The interface entity 701 may be a radio interface entity, for example a remote radio head, providing the apparatus with capability for radio communications. The entity 702 may be a processor, unit, module, etc. suitable for carrying out embodiments or operations described above, for example by means of FIG. 2 and/or FIG. 3 and/or FIG. 4 and/or FIG. 5 and/or FIG. 6.

In other words, an apparatus configured to provide the wireless access apparatus (access node), or an apparatus configured to provide one or more corresponding functionalities as described above, for example by means of FIG. 2 and/or FIG. 3 and/or FIG. 4 and/or FIG. 5 and/or FIG. 6, is a computing device that may be any apparatus or device or equipment or node configured to perform one or more of corresponding apparatus functionalities described with an embodiment/example above, for example by means of FIG. 2 and/or FIG. 3 and/or FIG. 4 and/or FIG. 5 and/or FIG. 6, and it may be configured to perform functionalities from different embodiments/examples. The guard band adjusting unit, as well as corresponding units and sub-unit and other units, and/or entities described above with an apparatus may be separate units, even located in another physical apparatus, the distributed physical apparatuses forming one logical apparatus providing the functionality, or integrated to another unit in the same apparatus.

The apparatus configured to provide the wireless access apparatus (access node), or an apparatus configured to provide one or more corresponding functionalities described above, for example by means of FIG. 2 and/or FIG. 3 and/or FIG. 4 and/or FIG. 5 and/or FIG. 6, may generally include a processor, controller, control unit, micro-controller, or the like connected to a memory and to various interfaces of the apparatus. Generally the processor is a central processing unit, but the processor may be an additional operation processor. Each or some or one of the units/sub-units and/or algorithms for functions/operations described herein, for example by means of FIG. 2 and/or FIG. 3 and/or FIG. 4 and/or FIG. 5 and/or FIG. 6, may be configured as a computer or a processor, or a microprocessor, such as a single-chip computer element, or as a chipset, including at least a memory for providing storage area used for arithmetic operation and an operation processor for executing the arithmetic operation. Each or some or one of the units/sub-units and/or algorithms for functions/operations described above, for example by means of FIG. 2 and/or FIG. 3 and/or FIG. 4 and/or FIG. 5 and/or FIG. 6, may comprise one or more computer processors, application-specific integrated circuits (ASIC), digital signal processors (DSP), digital signal processing devices (DSPD), programmable logic devices (PLD), field-programmable gate arrays (FPGA), and/or other hardware components that have been programmed and/or will be programmed by downloading computer program code (one or more algorithms) in such a way to carry out one or more functions of one or more embodiments/examples. An embodiment provides a computer program embodied on any client-readable distribution/data storage medium or memory unit(s) or article(s) of manufacture, comprising program instructions executable by one or more processors/computers, which instructions, when loaded into an apparatus, constitute the guard band adjusting unit or an entity providing corresponding functionality. Programs, also called program products, including software routines, program snippets constituting “program libraries”, applets and macros, can be stored in any medium and may be downloaded into an apparatus. In other words, each or some or one of the units/sub-units and/or the algorithms for one or more functions/operations described above, for example by means of FIG. 2 and/or FIG. 3 and/or FIG. 4 and/or FIG. 5 and/or FIG. 6, may be an element that comprises one or more arithmetic logic units, a number of special registers and control circuits.

Further, the apparatus configured to provide the wireless access apparatus (access node), or an apparatus configured to provide one or more corresponding functionalities described above, for example by means of FIG. 2 and/or FIG. 3 and/or FIG. 4 and/or FIG. 5 and/or FIG. 6, may generally include volatile and/or non-volatile memory, for example EEPROM, ROM, PROM, RAM, DRAM, SRAM, double floating-gate field effect transistor, firmware, programmable logic, etc. and typically store content, data, or the like. The memory or memories may be of any type (different from each other), have any possible storage structure and, if required, being managed by any database management system. In other words, the memory may be any computer-usable non-transitory medium within the processor, or corresponding entity suitable for performing required operations/calculations, or external to the processor or the corresponding entity, in which case it can be communicatively coupled to the processor or the corresponding entity via various means. The memory may also store computer program code such as software applications (for example, for one or more of the units/sub-units/algorithms) or operating systems, information, data, content, or the like for the processor or the corresponding entity to perform steps associated with operation of the apparatus in accordance with examples/embodiments. The memory, or part of it, may be, for example, random access memory, a hard drive, or other fixed data memory or storage device implemented within the processor/apparatus or external to the processor/apparatus in which case it can be communicatively coupled to the processor/network node via various means as is known in the art. An example of an external memory includes a removable memory detachably connected to the apparatus, a distributed database and a cloud server.

The apparatus configured to provide the wireless access apparatus (access node), or an apparatus configured to provide one or more corresponding functionalities described above, for example by means of FIG. 2 and/or FIG. 3 and/or FIG. 4 and/or FIG. 5 and/or FIG. 6, may generally comprise different interface units, such as one or more receiving units and one or more sending units. The receiving unit and the transmitting unit each provides an interface entity in an apparatus, the interface entity including a transmitter and/or a receiver or any other means for receiving and/or transmitting information, and performing necessary functions so that the information, etc. can be received and/or sent. The receiving and sending units/entities may be remote to the actual apparatus and/or comprise a set of antennas, the number of which is not limited to any particular number.

It will be obvious to a person skilled in the art that, as the technology advances, the inventive concept can be implemented in various ways. The invention and its embodiments are not limited to the examples described above but may vary within the scope of the claims.

1. A method comprising:
determining a first transmission mode used in a first frequency band and a second transmission mode used in a second frequency band that is adjacent to the first frequency band;
comparing the first transmission mode with the second transmission mode; and
determining, based on an outcome of the comparing, a size of a guard band to be used between the first frequency band and the second frequency band.

2. A method as claimed in claim 1, further comprising:
in response to both the first transmission mode and the second transmission mode being a frequency division duplex mode, using a small or zero size guard band.

3. A method as claimed in claim 1, further comprising:
in response to both the first transmission mode and the second transmission mode being a time division duplex mode that are synchronized, using a small or zero size guard band.

4. A method as claimed in claim 1, further comprising:
in response to the first transmission mode and the second transmission mode being a time division duplex mode that are asynchronous, using a large guard band.

5. A method as claimed in claim 1, further comprising:
in response to the first transmission mode and the second transmission mode being a time division duplex uplink mode that are asynchronous, using a small or zero size guard band;
in response to the first transmission mode and the second transmission mode being a time division duplex downlink mode that are asynchronous, using a small or zero size guard band; and
in response one of the first transmission mode and the second transmission mode being a time division duplex uplink mode and the other one being a time division duplex downlink mode that are asynchronous, using a large guard band.

6. A method as claimed in claim 1, further comprising:
in response to one of the first transmission mode and second transmission mode being in a time division duplex mode and the other one being in a frequency division duplex mode, using a large guard band.

7. A method as claimed in claim 1, further comprising:
in response to one of the first transmission mode and second transmission mode being in a time division duplex uplink mode and the other one being in a frequency division duplex mode, using a large guard band; and
in response to one of the first transmission mode and second transmission mode being in a time division duplex downlink mode and the other one being in a frequency division duplex mode, using a small or zero size guard band.

8. A method as claimed in claim 1, further comprising:
in response to one of the first transmission mode and second transmission mode being in a time division duplex downlink mode and transmitting and the other one being in a frequency division duplex uplink mode and receiving, using a large guard band;
in response to one of the first transmission mode and second transmission mode being in a time division duplex downlink mode and the other one being in a frequency division duplex uplink mode, and at least one of the frequency bands being inactive, using a small or zero size guard band;
in response to one of the first transmission mode and second transmission mode being in a time division duplex downlink mode and the other one being in a frequency division duplex downlink mode, using a small or zero size guard band;
in response to one of the first transmission mode and second transmission mode being in a time division uplink mode and receiving and the other one being in a frequency division duplex downlink mode and transmitting, when the frequency bands allocated for the traffic are close, using a large guard band;
in response to one of the first transmission mode and second transmission mode being in a time division uplink mode and the other one being in a frequency division duplex downlink mode and at least one of the frequency bands being inactive or the frequency bands allocated for the traffic are not close to each other, using a small or zero size guard band; and
in response to one of the first transmission mode and second transmission mode being in a time division duplex uplink mode and the other one being in a frequency division duplex uplink, using a small or zero size guard band.

9. A method as claimed in claim 1, further comprising:
determining a load in the first frequency band;
if the load does not exceed a predefined threshold, using a large guard band;
otherwise determining the first transmission mode and the second transmission mode and the size of the guard band to be used in the first frequency band.

10. A method as claimed in claim 1, wherein the determining the size of the guard band to be used is performed sub-frame-specifically.

11. A method as claimed in claim 1, wherein the determining of the second transmission mode and the size of the guard band to be used in the first frequency band is performed in response to the first transmission mode being a time division duplex mode.

12. A method as claimed in claim 1, wherein the determining of the size of the guard band to be used in the first frequency band is performed in response to the second transmission mode being a time division duplex mode.

13. A method as claimed in claim 1, further comprising:
causing sending information on the size of the guard band to one or more user devices.

14. An apparatus comprising:
a radio interface entity providing the apparatus with capability for radio communications over a first frequency band;
at least one processor and at least one memory including a computer program code, the at least one memory and the computer program code configured to, with the at least one processor, cause the apparatus at least to:
determine a first transmission mode used in the first frequency band and a second transmission mode used in a second frequency band that is adjacent to the first frequency band; compare the first transmission mode with the second transmission mode; and
determine, based on an outcome of the comparing, a size of a guard band to be used between the first frequency band and the second frequency band.

15. An apparatus as claimed in claim 14, wherein the at least one memory and the computer program code configured to, with the at least one processor, further cause the apparatus to:
use a small or zero size guard band in response to both the first transmission mode and the second transmission mode being a frequency division duplex mode.

16. An apparatus as claimed in claim 14, wherein the at least one memory and the computer program code configured to, with the at least one processor, further cause the apparatus to:
use a small or zero size guard band in response to both the first transmission mode and the second transmission mode being a time division duplex mode that are synchronized.

17. An apparatus as claimed in claim 14, wherein the at least one memory and the computer program code configured to, with the at least one processor, further cause the apparatus to:
use a large guard band in response to the first transmission mode and the second transmission mode being a time division duplex mode that are asynchronous.

18. An apparatus as claimed in claim 14, wherein the at least one memory and the computer program code configured to, with the at least one processor, further cause the apparatus to:
use a small or zero size guard band in response to the first transmission mode and the second transmission mode being a time division duplex uplink mode that are asynchronous;
use a small or zero size guard band in response to the first transmission mode and the second transmission mode being a time division duplex downlink mode that are asynchronous; and
use a large guard band in response one of the first transmission mode and the second transmission mode being a time division duplex uplink mode and the other one being a time division duplex downlink mode that are asynchronous.

19. An apparatus as claimed in claim 14, wherein the at least one memory and the computer program code configured to, with the at least one processor, further cause the apparatus to:
use a large guard band in response to one of the first transmission mode and second transmission mode being in a time division duplex mode and the other one being in a frequency division duplex mode.

20. An apparatus as claimed in claim 14, wherein the at least one memory and the computer program code configured to, with the at least one processor, further cause the apparatus to:
use a large guard band in response to one of the first transmission mode and second transmission mode being in a time division duplex uplink mode and the other one being in a frequency division duplex mode; and
use a small or zero size guard band in response to one of the first transmission mode and second transmission mode being in a time division duplex downlink mode and the other one being in a frequency division duplex mode.

21. An apparatus as claimed in claim 14, wherein the at least one memory and the computer program code configured to, with the at least one processor, further cause the apparatus to:
use a large guard band in response to one of the first transmission mode and second transmission mode being in a time division duplex downlink mode and transmitting and the other one being in a frequency division duplex uplink mode and receiving;
use a small or zero size guard band in response to one of the first transmission mode and second transmission mode being in a time division duplex downlink mode and the other one being in a frequency division duplex uplink mode, and at least one of the frequency bands being inactive;
use a small or zero size guard band in response to one of the first transmission mode and second transmission mode being in a time division duplex downlink mode and the other one being in a frequency division duplex downlink mode;
use a large guard band in response to one of the first transmission mode and second transmission mode being in a time division uplink mode and receiving and the other one being in a frequency division duplex downlink mode and transmitting, when the frequency bands allocated for the traffic are close to each other;
use a small or zero size guard band in response to one of the first transmission mode and second transmission mode being in a time division uplink mode and the other one being in a frequency division duplex downlink mode and at least one of the frequency bands being inactive or the frequency bands allocated for the traffic are not close to each other; and
use a small or zero size guard band in response to one of the first transmission mode and second transmission mode being in a time division duplex uplink mode and the other one being in a frequency division duplex uplink or downlink mode.

22. An apparatus as claimed in claim 14, wherein the at least one memory and the computer program code configured to, with the at least one processor, perform the process sub-frame-specifically:

23. An apparatus as claimed in claim 14, wherein the at least one memory and the computer program code configured to, with the at least one processor, further cause the apparatus to:
determine a load in the first frequency band;
use a large guard band in response to the load not exceeding a predefined threshold; and
determine the first transmission mode and the second transmission mode and the size of the guard band to be used in the first frequency band in response to the load exceeding the predefined threshold.

24. An apparatus as claimed in claim 14, wherein the at least one memory and the computer program code configured to, with the at least one processor, further cause the apparatus to send information on the size of the guard band to one or more user devices.

25. (canceled)

26. A non-transitory computer readable media having stored there-on instructions that, when executed by an apparatus, cause the apparatus to:
determine a first transmission mode used a the first frequency band and a second transmission mode used in a second frequency band that is adjacent to the first frequency band;
compare the first transmission mode with the second transmission mode; and
determine, based on an outcome of the comparing, a size of a guard band to be used between the first frequency band and the second frequency band.

27. (canceled)

28. (canceled)
